(19) United States
(12) Patent Application Publication
(10) Pub. No.: US 2020/0395135 A1
(43) Pub. Date: Dec. 17, 2020

(54) INTEGRAL PRESSURE VESSEL PENETRATIONS AND SYSTEMS AND METHODS FOR USING AND FABRICATING THE SAME

(71) Applicant: GE-Hitachi Nuclear Energy Americas LLC, Wilmington, NC (US)

(72) Inventors: Christer N. Dahlgren, Wilmington, NC (US); Gary M. Anthony, Wilmington, NC (US); Joel P. Melito, Wilmington, NC (US)

(21) Appl. No.: 16/900,977

(22) Filed: Jun. 14, 2020

Related U.S. Application Data
(60) Provisional application No. 62/861,328, filed on Jun. 14, 2019.

(51) Int. Cl. G21C 13/024; G21C 9/004; G21C 1/08

(52) U.S. Cl. CPC G21C 13/024; G21C 17/042; G21C 1/086; G21C 9/004

(57) ABSTRACT

Pressure vessels have full penetrations that can be opened and closed with no separate valve piping or external valve. A projected volume from the vessel wall may house valve structures and flow path, and these structures may move with an external actuator. The flow path may extend both along and into the projected volume. Vessel walls may remain a minimum thickness even at the penetration, and any type of gates may be used with any degree of duplication. Penetrations may be formed by installing valve gates directly into the channel in the wall. The wall may be built outward into the projected volume by forging or welding additional pieces integrally machining the channel through the same volume and wall. Additional passages for gates and actuators may be machined into the projections as well. Pressure vessels may not require flanges at join points or material seams for penetration flow paths.

### RELATED APPLICATIONS

This application claims priority under 35 U.S.C. § 119 to co-pending U.S. Provisional Application 62/861,328, filed Jun. 14, 2019 and incorporated by reference herein in its entirety.

### BACKGROUND

FIGS. 1 and 2 are schematics of related art pressure vessel isolation valves, similar to those in U.S. Pat. No. 9,721,685 to Malloy, III et al.; U.S. Pat. No. 9,922,740 to Singh et al.; U.S. Pat. No. 10,026,511 to Malloy, III et al.; and U.S. Pat. No. 10,529,458 to Kanuch et al., all of which are incorporated herein by reference in their entireties. As shown in FIG. 1, multiple isolation valves 11 are positioned at penetrations in pressure vessel 10, such as a nuclear reactor pressure vessel. Valves 11 are useable to control fluid flow through these penetrations. As seen in the left detail of FIG. 1, valve 11 may join to a penetration at a flange interface 12 where valve 11 seats against reactor 10. One or more bolts 13 or other mechanical fasteners compress valve 11 to flange interface 12, which typically extends about a larger perimeter to accommodate additional bolting and contact between joined structures. As seen in FIG. 2, bolts 13 may pass through multiple holes in both flange interface 12 and valve 11 and be tightened to form a connection. Bolts 13 may be loosened and removed from flange interface 12 to easily separate valve 11 from reactor 10 during maintenance and decommissioning. Because valves 11 in FIGS. 1 and 2 are separate from reactor 10 and flange 12, they may be swapped and replaced based on desired function and for ease of separate shipping.

### SUMMARY

Example methods and embodiments include pressure vessels, such as nuclear reactor pressure vessels housing a core for electricity generation with integral, valved penetrations passing entirely through the wall of the pressure vessel. The valved penetrations allow control of flow paths through the reactor, such as a primary coolant or ICS loop, without the need for external flanges, mechanical connections, bolts, spot welds, etc., as there is minimal risk of continuous pressure vessel material breaking. Every vessel penetration may use integral valve penetrations to further minimize risk. An extension from the vessel wall may house the valve structures and flow path, and the valve may with a moveable gate in the flow path with external actuator for moving the same to desired open or closed positions. The flow path may extend both along and into the extension, so as to preserve wall thickness and provide a length for valve gate and actuator positioning along the extension. Any number or type of gates may be used, including ball and swing gates. Example methods form the penetrations by creating the flow path through the vessel wall and placing the valve gates directly into the channel in the wall. The wall may be built outward into the extension at the penetration by forging or welding additional plates or segments integrally to the wall and machining the channel through the extension. Additional passages for gate valves and/or actuators may be machined into the extensions as well.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is an illustration of a related art nuclear reactor pressure vessel with penetrations.

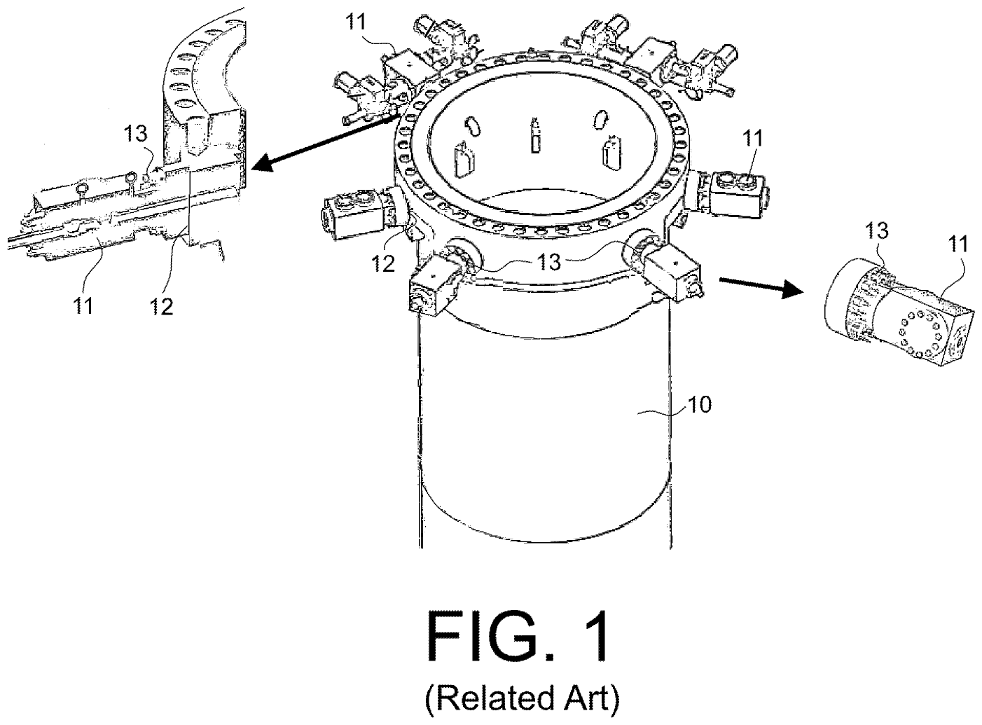

FIG. 2 is an illustration of a related art nuclear reactor pressure vessel penetration.

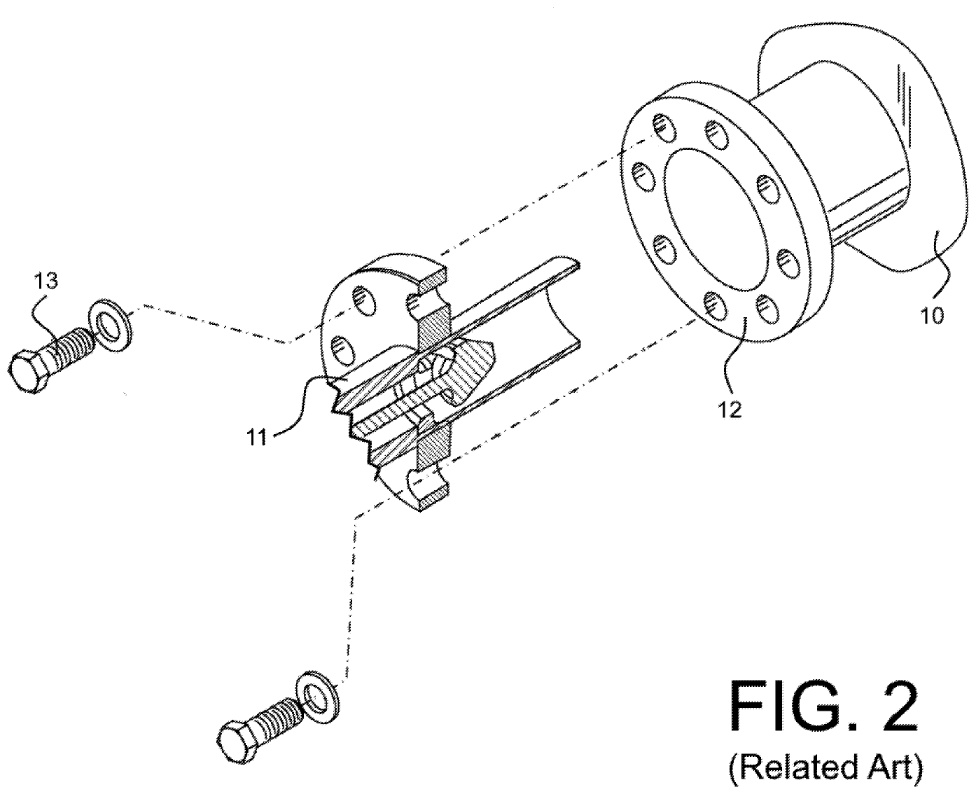

FIGS. 3A and 3B are illustrations of example embodiment pressure vessels with integral penetrations.

FIG. 4 is an illustration of an example embodiment integral penetration with valve in a hub.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

Modifiers “first,” “second,” “another,” etc. may be used herein to describe various items, but they do not confine modified items to any order. These terms are used only to distinguish one element from another; where there are “second” or higher ordinals, there merely must be that many number of elements, without necessarily any difference or other relationship. For example, a first element could be termed a second element, and, similarly, a second element could be termed a first element unless an order or difference is separately stated. In listing items, the conjunction “and/or” includes all combinations of one or more of the associated listed items. The use of “etc.” is defined as “et cetera” and indicates the inclusion of all other elements belonging to the same group of the preceding items, in any “and/or” combination(s).

When an element is related, such as by being “connected,” “coupled,” “mated,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two devices, including intermediary devices, networks, etc., connected wirelessly or not.

As used herein, singular forms like “a,” “an,” and the are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. Possessive terms like “comprises,” “includes,” “has,” or “with” when used herein, specify the presence of stated features, characteristics, steps, operations, elements, and/or components, but do not themselves preclude the presence or addition of one or more other features, characteristics, steps, operations, elements, components, and/or groups thereof. Rather, exclusive modifiers like “only” or “singular” may preclude presence or addition of other subject matter in modified terms.

As used herein, “axial” and “vertical” directions are the same up or down directions oriented along the major axis of a nuclear reactor, often in a direction oriented with gravity. “Transverse” directions are perpendicular to the “axial” and are side-to-side directions at a particular axial height. As used herein, “integral” and “integrally” are defined as “with material continuity and inseparability, including single-piece forged and welded materials at ASME nuclear specifications.” As such, integral connections do not include bare mechanical or compressive joining between pieces, where pieces may be disconnected without internal separation or without cutting or destruction of an individual piece.

The structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, so as to provide looping or other series of operations aside from single operations described below. It should be presumed that any embodiment or method having features and functionality described below, in any workable combination, falls within the scope of example embodiments.

The inventors have recognized that mechanical penetrations present a material seam, or discontinuity, in flow paths across a wall through which a fluid, such as reactor coolant or moderator, may leak. Separate valves joining to these penetrations through bolting or other compressive joints may have several failure modes not seen in integral structures. Moreover, separate valves and piping for the same may require several different components to be shipped, assembled, and disassembled, increasing complexity and cost of manufacture and installation. The inventors have developed example embodiments and methods described below to address these and other problems recognized by the Inventors with unique solutions enabled by example embodiments.

The present invention is pressure vessels with a valved, integral penetration through the vessel, methods of forming the same, and plant systems using the same. In contrast to the present invention, the few example embodiments and example methods discussed below illustrate just a subset of the variety of different configurations that can be used as and/or in connection with the present invention.

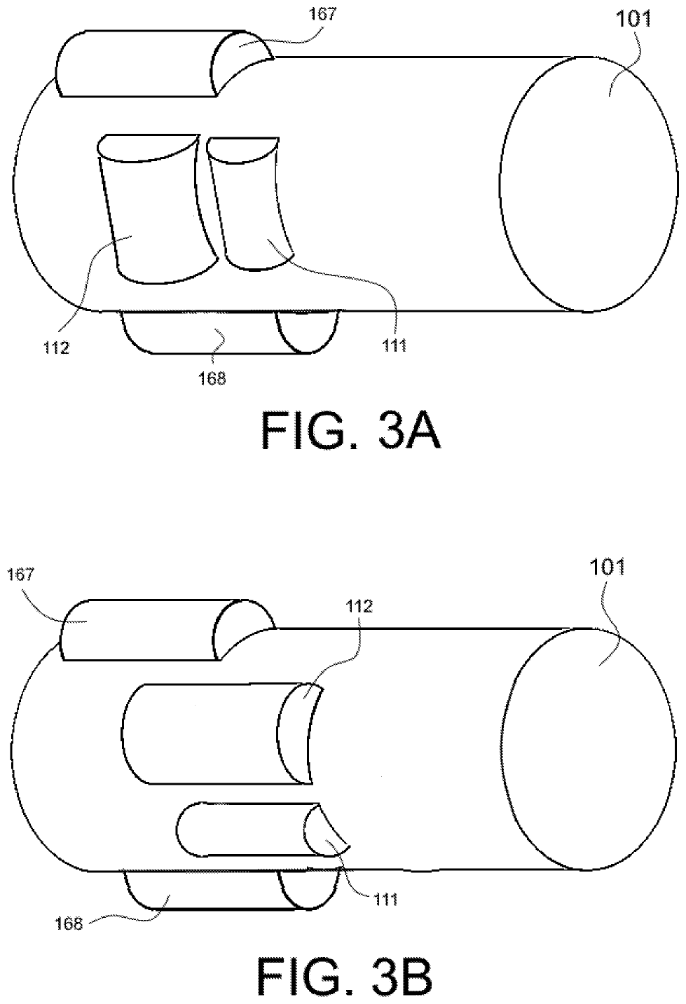

FIG. 3 is an illustration of an example embodiment pressure vessel 101, including a nuclear reactor pressure vessel that may contain a core with nuclear fuel, several internal structures, and a removeable head (not shown). Pressure vessel 101 may be generally cylindrical or any other shape, with one or more valve hubs on its exterior where a vessel penetration is formed. For example, as shown in FIGS. 3A and 3B, main steam valve hub 112 may be paired with main feedwater valve hub 111 to provide a typical coolant/moderator loop through pressure vessel 101. Similarly, isolation condenser system valve hubs 168 and 167 may be paired on opposite sides of pressure vessel 101 to provide a transient or offline cooling of the coolant/moderator loops through an isolation condenser system. Valve hubs may be formed at any desired elevation or orientation, wherever a vessel penetration is desired. For example, any or all of the integral valve connections in US Patent Publications 2018/0322966 to Hunt et al.; 2019/0006052 to Hunt et al.; and 2019/0057785 to Hunt et al., incorporated by reference herein in their entireties, may be formed as example embodiments using valve hubs like in FIGS. 3A and 3B.

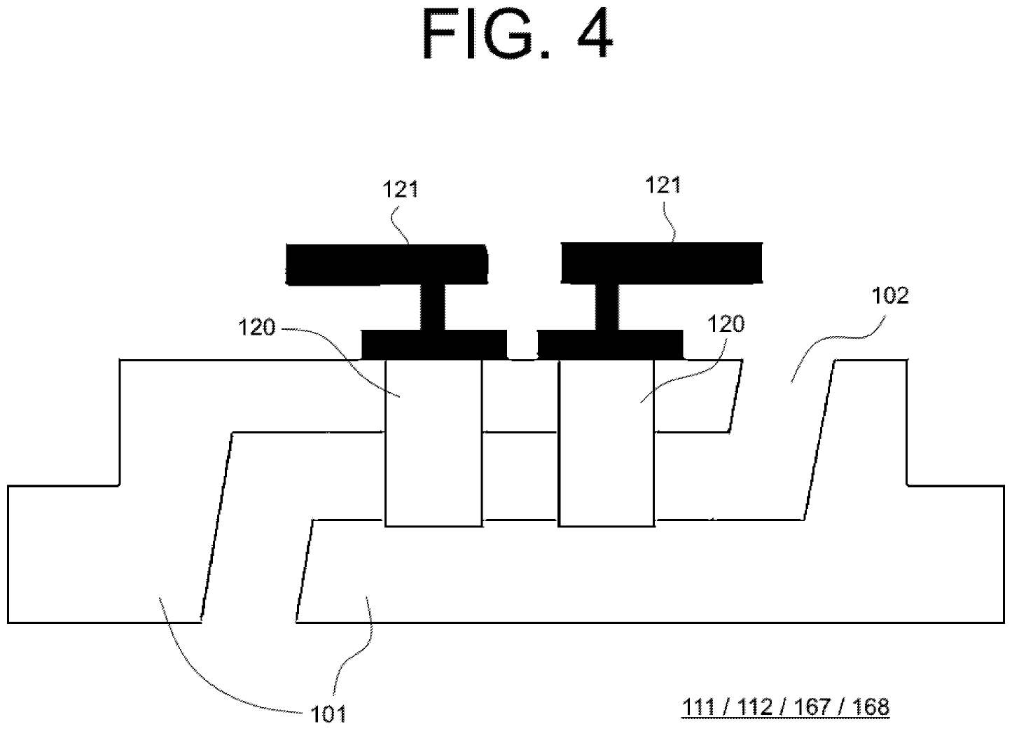

FIG. 4 is an illustration of an example embodiment valve hub, such as valve hubs 111, 112, 167, and/or 168 in pressure vessel 101. As seen in FIG. 4, a valve body is formed by pressure vessel 101 itself in valve hub 111/112/167/168, with a flow path 102 formed therein passing entirely through pressure vessel 101, from an exterior at top to an interior at bottom. As shown in FIG. 4, flow path 102 may extend both vertically and horizontally, through a longest dimension of valve hub 111/112/167/168 while proceeding inward, thereby allowing a large flow path 102 that is still surrounded by a same minimum thickness of vessel 101 while allowing additional space for valve operations on hub 111/112/167/168. While flow path 102 may extend in any direction, a two-dimensionally-directed path into and along hub 111/112/167/168 may present a simple path with less frictional and hydrodynamic losses due to directional change.

One or more gates 120 extend into flow path 102 to selectively block flow through the same, thereby opening or closing valve hub 111/112/167/168. Gates 120 may be configured in any shape and operation range that permit reliable opening and closing of flow path 102; for example, gates 120 may be swings, balls, wedges, parallel disks, stems, etc., including the various types in IMI NH, “Valves and Systems for Nuclear Industries,” NI Product Range, February 2018, incorporated by reference herein in its entirety. Gates 120 may seat through and/or be captured in, pressure vessel 101 in valve hubs 111/112/167/168, with gaskets, blocking flanges, lubricant, seals, etc. to allow reliable movement without the possibility of leakage, failure, or expulsion from valve hubs 111/112/167/168.

Actuator 121 is connected to one or more gates 120 to move the same between open and closed positions. For example, actuator 121 may be a manual handle directly and integrally connected to gate 120, allowing for manual valve operation. Similarly, actuator 121 may be remote and/or a motor, solenoid, pneumatic, or mechanically-operated actuator, or any other type of actuator, that can reliably open gates 120 from an operator signal or plant system trigger. In this way, one or more gates 120 may allow selective flow through flow path 102, thereby opening or closing valve hubs and penetrations containing the same through reactor vessel 101.

Example methods form integral valves such as those in FIGS. 3 and 4. In the example of a pressure vessel, example methods include incrementally building up vessel wall plates, rings, or segments during typical pressure vessel construction, through additive manufacturing, forging, and/or integral welding. A hub may be formed through adding additional plates, rings, or segments, directly through additive manufacturing, and/or through removing additional material about the hubs, to form an extension, appurtenance, etc. on the vessel wall. Optionally, no hub may be used.

Example methods form the flow path and valve channel through machining from the vessel wall, potentially through the hub, creating an integral valved penetration. Any additional valve housings and channels, such as to allow gate passage or capture a gate, may be machined from the vessel wall as well. Of course, such passages may also be formed during forging and additive manufacture. Valve gates, actuators, and other valve structures may be directly cut from the vessel and/or installed in penetrations after forming.

Any piping, such as a main steam leg or feedwater line, connected externally may be integrally formed with the penetration, such as through ASME nuclear welding to form integral structures. Example embodiment valves can thus be manufactured without external flanges or mechanical join points to the vessel but may be vessel components themselves. In this way, example embodiment valves may simply open into the pressure vessel internal, such that the flow path, aside from a gate, does not include any seam or material disruption along its entire path from outside the vessel to inside. And example methods and embodiments provide a way to integrate pressure vessel isolation valves into the vessel itself that is easy to manufacture, eliminates piping between vessel and valves, and enables easier manufacture and transportation of the final assembled vessel component with fewer pieces. Elimination of piping systems for reactor pressure vessel isolation valves also reduces SSC for nuclear plants that would otherwise be necessary to mitigate a large valve break LOCA that cannot happen with integral connections.

Some example embodiments and methods thus being described, it will be appreciated by one skilled in the art that examples may be varied through routine experimentation and without further inventive activity. For example, although a cylindrical pressure vessel with specific types of penetrations is used in some examples, it is understood that other vessels and penetrations are useable with examples. Variations are not to be regarded as departure from the spirit and scope of the example embodiments, and all such modifications as would be obvious to one skilled in the art are intended to be included within the scope of the following claims.

What is claimed is:

1. A pressure vessel comprising:
a wall defining an interior and an exterior of the pressure vessel; and
a penetration integral with the wall forming a flow path through the wall, wherein the penetration includes an integral valve openable and closeable from the exterior.

2. The pressure vessel of claim 1, wherein the penetration includes a hub integral with the wall and extending outward toward the exterior, and wherein the valve is in the hub.

3. The pressure vessel of claim 2, wherein the hub defines the flow path from the exterior to the interior, wherein the valve further includes at least one gate in the flow path configured to open and close the flow path.

4. The pressure vessel of claim 1, wherein the penetration includes no external flange or structure compressed to the valve or the wall.

5. The pressure vessel of claim 1, wherein the flow path extends in at least two different dimensions through the penetration.

6. The pressure vessel of claim 1, wherein the valve further includes at least one gate in the flow path configured to open and close the flow path.

7. The pressure vessel of claim 6, wherein the valve includes two of the gates, and wherein the gates are swing gates.

8. The pressure vessel of claim 6, wherein the valve further includes an actuator on the exterior connected to the at least one gate and configured to move the gate between open and closed positions.

9. A nuclear reactor pressure vessel comprising:
a cylindrical wall configured to surround a nuclear core; and
a first penetration integral with the wall including a flow path from an exterior of the vessel to an interior of the vessel, wherein the first penetration includes a valve opening and closing the flow path through the wall.

10. The nuclear reactor pressure vessel of claim 9, wherein the wall is cylindrical or annular.

11. The nuclear reactor pressure vessel of claim 9, further comprising:
a second penetration integral with the wall including a flow path from an exterior of the vessel to an interior of the vessel, wherein the second penetration includes a valve opening and closing the flow path through the wall.

12. The nuclear reactor pressure vessel of claim 11, wherein the first and the second penetration form at least one of a main coolant loop through the vessel and an ICS loop through the vessel.

13. The nuclear reactor pressure vessel of claim 9, wherein all penetrations through the wall from the exterior to the interior are integral with the all and include a valve opening and closing the flow path through the wall.

14. The nuclear reactor pressure vessel of claim 9, wherein the first penetration includes a hub integral with the wall and extending outward toward the exterior, and wherein the valve is in the hub.

15. The nuclear reactor pressure vessel of claim 14, wherein the hub defines the flow path from the exterior to the interior, wherein the valve further includes at least one gate in the flow path configured to open and close the flow path.

16. The nuclear reactor pressure vessel of claim 9, wherein the first penetration includes no external flange or structure compressed to the valve or the wall.

17. The nuclear reactor pressure vessel of claim 9, wherein the flow path extends both along the first penetration in a first dimension and into the first penetration in second direction perpendicular to the first direction.

18. The nuclear reactor pressure vessel of claim 9, wherein the valve further includes at least two gates in the flow path configured to open and close the flow path and an actuator on the exterior connected to the at least one gate and configured to move the gate between open and closed positions.

19. A method of forming penetrations integral with a pressure vessel, the method comprising:
forming a channel that passes entirely through a wall of the pressure vessel from an exterior of the pressure vessel to an interior of the pressure vessel; and
installing at least one valve gate directly in the wall to open and close the channel.

20. The method of claim 19, further comprising:
forming a hub by adding plate or ring segments integrally to the wall, wherein the forming the channel includes machining the channel through the hub so that the channel extends in a direction other than orthogonal with and directly through the wall at the penetration.
